(19) United States
(12) Patent Application Publication
(10) Pub. No.: US 2021/0387883 A1
(43) Pub. Date: Dec. 16, 2021

(54) SYSTEM AND METHOD FOR RESTORING RIVER AND LAKE WATER BODY BY FLOATING TYPE WATER PURIFICATION PLANT

(71) Applicant: CHINESE RESEARCH ACADEMY OF ENVIRONMENTAL SCIENCES, Beijing (CN)

(72) Inventors: Lieyu Zhang, Beijing (CN); Quiheng Zhu, Beijing (CN); Guowen Li, Beijing (CN); Xiaoguang Li, Beijing (CN); Caole Li, Beijing (CN); Wei Li, Beijing (CN); Jiaqian Li, Beijing (CN); Lulu Che, Beijing (CN); Chen Zhao, Beijing (CN)

(21) Appl. No.: 17/281,086

(22) PCT Filed: Sep. 15, 2020
(86) PCT No.: PCT/CN2020/115351

§ 371 Date: Mar. 29, 2021

(30) Foreign Application Priority Data
Sep. 29, 2019 (CN) 201910931254.8

(51) Int. Cl. C02F 9/00; C02F 3/32; C02F 3/34; C02F 1/48; C02F 1/00; C02F 1/52

(52) U.S. Cl. CPC C02F 9/00; C02F 3/327; C02F 3/34; C02F 2103/007; C02F 1/001; C02F 1/5236; C02F 2001/007; C02F 1/481

(57) ABSTRACT

The present invention relates to the field of water environment treatment, and particularly discloses a system and method for restoring a river and lake water body by a floating type water purification plant. The method comprises: (1) under the action of a water pump, enabling the river and lake water body to pass through a grille to be filtered; (2) lifting the filtered water body to an ss sedimentation tank by the water pump through a water inlet pipe, and carrying out pre-magnetization on the water body in the water inlet pipe by a pre-magnetization device arranged in the water inlet pipe; (3) enabling the water body subjected to pre-magnetization treatment to enter the ss sedimentation tank so as to remove particles in the water body; (4) enabling the water body treated by the ss sedimentation tank to enter a magnetizer to be subjected to magnetization treatment under a magnetic field intensity of 50 mT to 2,000 mT; and (5) distributing the water body subjected to magnetization treatment at the upper part of the floating type purification plant. According to the present invention, for the river and lake water body, for different growth periods of aquatic plants, the magnetic field intensity of the magnetizer for carrying out magnetization treatment on the water body is regulated for inducing growth of plants and beneficial indigenous microorganism communities, so that the purifying capacity and reliability of an ecological floating bed technology are reinforced.

### TECHNICAL FIELD

The present invention relates to the field of water environment treatment, and particularly, relates to a system and method for restoring a river and lake water body by a floating type water purification plant.

### BACKGROUND

A conventional river and lake floating type purification plant mainly utilizes a restoration technology of planting aquatic plants by using a high molecular material as a carrier, and in the restoration technology, the high molecular material is taken as the carrier and a substrate, nutrient substances such as nitrogen and phosphorus in a water body are absorbed, adsorbed and intercepted by plant root systems, and pollutants are moved out of the water body in a form of harvesting plant bodies so as to fulfill the aim of purifying water.

Plants on an ecological floating bed not only can directly utilize roots to absorb the nutrient substances in the water body, but also can convey oxygen to the roots to create favorable conditions for growth and reproduction of microorganisms at the roots and degradation of the pollutants so as to reinforce microorganism effects of root zones. When flowing through the root zones of the plants, the pollutants in water are removed under the action of assimilation, adsorption, oxygenolysis and the like of the microorganisms, and thus, the microorganisms in the root zones forms one of important functional zones of the ecological floating bed and influence the purification effect of the ecological floating bed.

A conventional ecological floating bed utilizes own metabolism to transform the pollutants into plant bodies and metabolites such as carbon dioxide, can effectively remove the pollutants in the water body, and has the advantages of small investment, easiness for management, no environment risk and the like. However, plant growth is easily affected by external environment factors such as temperature, lighting and the like, resulting in low survival rate, rooting rate, adherent microorganism effects and the like of the plants, thereby severely influencing treatment efficiency of the ecological floating bed. A purification principle of the ecological floating bed is that the pollutants in the water are removed by combined effects of the plants and the microorganisms, but in a polluted river and lake water body, indigenous microorganisms are single in community structure and low in functionality, resulting in weak effects of the microorganisms.

Chinese Patent Application No. CN102329002A discloses application of a plant ecological floating bed to restoration of a eutrophic water body, plants adopted by the ecological floating bed are combined plants of alocasia odora and common calla in a plant number ratio of (1 to 10):1, and a water inlet rate is 0.8 to 2.0 L/h; and before treatment, the eutrophic water body is added with ferric chloride. The technical solution disclosed by this document is to solve problems of poor reliability and low purifying capacity of ecological floating bed technical treatment, which are caused by temperature, however, there are also problems of inhibition on plant growth and the like in the actual operating process, and by tests of the ecological floating bed, it is found that plants with a high enrichment coefficient have low tolerance to a water body with a high pollution load, resulting in that growth of the plants is inhibited, thereby influencing the purification effect. The purification effect of the ecological floating bed does not only include effects of absorption, adsorption and the like of the plants, and the purification effect of the microorganisms at the plant root systems is also an important contributor. However, the solution does not consider the microorganism effect of the ecological floating bed, so that it is liable to cause low treatment efficiency of the ecological floating bed in the actual application process.

Therefore, constructing an efficient functional root system microorganism community is particularly important for improving the purification efficiency of the ecological floating bed.

### SUMMARY

The present invention is to provide a system and method for restoring a river and lake water body by a floating type water purification plant so as to solve at least one technical problem existing in the prior art.

In order to fulfill the objective of the present invention, the technical solution of the present invention is as follows:

in the first aspect, the present invention provides a system for restoring a river and lake water body by a floating type water purification plant, and the system at least comprises: a grille, a water pump, a pre-magnetization device, an ss sedimentation tank, a magnetizer and the floating type purification plant;
wherein:
the grille is used for filtering large-particle rubbish, plant residues and large-sized phytoplankton in the river and lake water body;
the water pump is used for enabling the water body to pass through the grille and lifting the water body passing through the grille to the ss sedimentation tank;
the pre-magnetization device is arranged in a water inlet pipe of the ss sedimentation tank, and used for carrying out pre-magnetization on the water body entering the ss sedimentation tank;
the ss sedimentation tank is used for rapidly settling particles in the water body;
the magnetizer is used for carrying out magnetization treatment on the water body treated by the ss sedimentation tank; and
the floating type purification plant utilizes the water body subjected to magnetization treatment by the magnetizer and combines with plants on the floating type purification plant to carry out purification or restoration on a natural water body.

Further, the pre-magnetization device is a multi-stage permanent magnetic type magnetization device.

In the second aspect, the present invention provides a method for restoring a river and lake water body by utilizing the above-mentioned system, and the method comprises the following steps:

(1) under the action of a water pump, enabling the river and lake water body to pass through a grille to be filtered;
(2) lifting the filtered water body to an ss sedimentation tank by the water pump through a water inlet pipe, and carrying out pre-magnetization on the water body in the water inlet pipe by a pre-magnetization device arranged in the water inlet pipe;
(3) enabling the water body subjected to pre-magnetization treatment to enter the ss sedimentation tank so as to remove particles in the water body;
(4) enabling the water body treated by the ss sedimentation tank to enter a magnetizer to be subjected to magnetization treatment under a magnetic field intensity of 50 mT to 2,000 mT; and
(5) distributing the water body subjected to magnetization treatment at the upper part of the floating type purification plant, wherein, aquatic plants are planted in the floating type purification plant.

Further, the grille used in the step (1) can be specifically regulated according to site situations, the specification of a rake tooth grille gap of the grille is 5 mm to 50 mm, and the grille has an installation angle of 60° to 70°, a maximum water passing flow rate of greater than or equal to 160 m³/h and a maximum liquid flow rate of greater than or equal to 0.3 m/s.

The used water pump is a submersible pump and can be set according to a site water body treatment flow rate, and in order to meet an ectopic treatment mode, the used submersible pump should have a lift of greater than or equal to 10 m and a maximum flow rate of greater than or equal to 160 m³/h.

Further, the pre-magnetization device in the step (2) is a permanent magnetic type magnetization device (a rare earth magnetization device), and is used for carrying out pre-magnetization on the water body. In one aspect, by pre-magnetization, physical and chemical properties of the water body are changed, and the solubility of the water body is improved, so that dosages of a subsequent flocculant and algicide are reduced; and in the other aspect, the magnetization effect for reinforcing the water body prolongs the magnetization time of the water body so as to prolong the magnetization retention time of the water body and enhance the magnetization effect.

Further, the ss sedimentation tank in the step (3) is a simple equalization tank, and by prolonging the retention time of river water, in one aspect, suspended particles in the water body are rapidly removed by utilizing gravity sedimentation, and subsequent magnetization of the water body is facilitated; and in the other aspect, water quality of the water body is more uniform.

Furthermore, in the step (3), chemical agents, e.g., the algicide such as complex copper sulfate and the flocculant such as poly aluminum chloride can be added according to the water quality and the chlorophyll a content of the water body.

When the ss content of the water body is greater than or equal to 150 mg/m³, or according to treatment demands, the flocculant such as PAC and/or PAM can be added to carry out flocculating sedimentation so as to reinforce a removal effect on pollutants such as ss, BOD and COD.

When the chlorophyll a content of the water body is greater than or equal to 10 mg/m³, phytoplankton in the water body can be removed by adding the chemical algicide, and the chemical algicide comprises chlorine dioxide, complex copper sulfate, glutaraldehyde, bromo-geramine and the like and has the characteristics of good sterilization effect, small side effects, high algae killing speed and the like.

Further, magnetization treatment conditions in the step (4) are that: magnetization time is 1 min to 30 min, and a magnetization intensity is 50 mT to 2,000 mT.

The magnetization principle in the step (4) is that when the water body is lifted by the water pump to enter the magnetizer, water flow does the motion of cutting magnetic lines in a magnetic field to generate charges and an electromotive force for enabling the charges to move, thereby enabling the water body to generate physical changes such as a current and a potential. After the current is generated in the water, states and properties of water and other substances in the water are changed. After the water is magnetized, an original structure is destroyed, associated water molecule groups with macro molecules are fractured into micro molecules and even single water molecules, and hydrogen bonds in the water evenly move rightwards; and the water is formed by polar molecules, after the water does the motion of cutting the magnetic field in the magnetic field, a generated Lorentz force can enable the water molecules to be directionally arranged, and a magnetic distance between atoms, a hydrogen bond angle and the like are changed so as to generate a series of changes of the physical and chemical properties.

It should be noted that different water bodies include different components which include ingredients of salt, alkali, acid, suspended matter, metal elements, non-metallic elements and the like, resulting in a difference in magnetic effect, and thus, proper regulation needs to be carried out in a magnetic field intensity range defined by the present invention on the basis of actual situations according to site water quality and the treatment objective.

Preferably, the setting of the magnetic field intensity in the magnetization reactor in the step (4) is divided into three magnetic field intensities according to plant growth phases as follows: 1, in a seed germination period, the magnetic field intensity is a low magnetic field intensity, i.e., 50 mT to 100 mT, and by the magnetic field, in one aspect, the associated water molecule groups with the macro molecules are changed into water molecule groups with the micro molecules so as to improve the permeability of a biological membrane and enable more nutrient substances and moisture to enter seeds, and in the other aspect, generation of cytokinin (CK), gibberellins (GA), abscisic acid (ABA) and auxin (IAA) is activated, these endogenous hormones, in the seed germination period, take an effect of rapidly releasing seed dormancy, promotes cell division and tissue differentiation, induces transport and accumulation of organic matter towards seeds, and can induce germination of the seeds so as to avoid necrosis of the seeds; 2, in a plant growth period, the magnetic field intensity is an intermediate magnetic field intensity, i.e., 100 mT to 1,000 mT, in one aspect, electron transport in the photosynthesis process of plants and generation of enzymes which participate in N metabolism and include glutamine synthetase (GS), glutamate synthase (GOGAT) and nitrate reductase (NR) can be promoted, and photosynthesis of aquatic plants and absorption of nutrient substances are enhanced, and in the other aspect, by regulating the magnetic field intensity, indoleacetic acid oxidase (IAAO) and peroxidase (POD) in the plant rooting process are stimulated and accumulation of (indoleacetic acid) IAA is promoted so as to promote rooting of the plants, enhance the absorbing ability of the plant root systems, provide more adhesions for root system microorganisms and enhance microorganism effects; and 3, in a plant decline period, the magnetic field intensity is a high magnetic field intensity, i.e., 500 mT to 2,000 mT, and preferably, 1,500 mT to 1,650 mT, and by regulating the high magnetic field intensity, an enzyme system composed of SOD, CAT and POD and used for effectively removing active oxygen is reinforced, and excessive active oxygen in organisms is timely removed so as to maintain a low active oxygen free radical level in bodies of the aquatic plants, avoid damage of the active oxygen to the aquatic plants and prolong the biological activity of the aquatic plants.

It should be noted that the magnetic field is selective for inhibition on bacterial growth, and different river channels are different in optimal magnetic field intensity suitable for indigenous microorganisms. Therefore, in the actual application, proper regulation can be carried out within the magnetic field conditions defined by the present invention according to specific situations. In one aspect, growth of beneficial indigenous microorganisms including microorganisms such as nitrifying bacteria and denitrifying bacteria is promoted, and a flora structure with high functionality of removing pollutants such as N and P is constructed; and in the other aspect, the magnetic field can promote mineralization of the organic matter and absorption of the microorganisms and can effectively promote generation of microorganism extracellular polysaccharides (EPS) for adsorbing the organic matter, and by regulating the magnetic field intensity, generation of functional enzymatic activities of N, P and the like is directionally promoted so as to further reinforce removal of the pollutants in the water body.

When the indigenous microorganisms are mainly chemoautotrophic or photoautotrophic microorganisms, e.g., thiobacteria, iron bacteria, chlamidotrix and nitrifying bacteria, preferably, a magnetic field intensity of 800 mT to 950 mT is adopted; when the indigenous microorganisms are mainly saprophytic bacteria, e.g., chromobacterium, achromobacter and micro coccobacillus, or are heterotrophic microorganism ammonifying bacteria, preferably, a magnetic field intensity of 600 mT to 700 mT is adopted; and when the indigenous microorganisms are mainly unicellular or filamentous algae, preferably, a magnetic field intensity of 300 mT to 500 mT is adopted.

Further, the floating type purification plant in the step (5) uses expanded polystyrene as a carrier, uses a PVC pipe as a structural framework of a floating type purification bed, and is subjected to gravity type fixing by a concrete cone with a height of 20 cm.

Wherein, the upper part of the floating type purification plant in the step (5) is an aquatic plant planting area, and the lower part of the floating type purification plant is a dispersed particle filler area. Filler is composed of conventional elastic filler and soft filler (e.g., ceramsite and aldehydated fibers) together, and not only provides a place for plant growth, but also provides more adhesion spaces for an indigenous microorganism flora. In order to achieve purification efficiency of the purification plant in different seasons, the aquatic plants optionally include canna indica, phragmites australis, yellow iris and iris tectorum, and preferably, the planting density of the aquatic plants is 1 to 2 Kg/m².

Raw materials involved in the present invention are all common commercial products, and operations involved in the present invention are all conventional operations in the art, unless otherwise specifically illustrated.

Based on the general knowledge in the art, the above-mentioned preferred conditions can be combined with each other to obtain specific embodiments.

The present invention has the beneficial effects that:

for the river and lake water body, the present invention is to provide the novel system and method for restoring the river and lake water body by the floating type purification plant through collaboration of a magnetized water technology and an ecological floating bed technology; and by regulating magnetization parameters, growth of the plants and the beneficial indigenous microorganism flora are induced, and the purifying capacity and reliability of the ecological floating bed technology are enhanced.

According to the present invention, the problem that an existing ecological floating bed is instable in system and liable to be influenced by environment factors is solved, and by taking the growth cycle of the plants as a phase and regulating a magnetization intensity of the magnetized water in different phases, plant growth in different growth phases is reinforced, influence of the environment factors on the plants is reduced, a growth rate, a survival rate, a rooting rate and the like of the plants on the ecological floating bed are improved, a water body pollution treatment effect of the aquatic plants is improved, and a treatment effect on the eutrophic water body is reinforced. Meanwhile, the present invention can also reduce the planting density of the aquatic plants on the floating type purification plant and reduce the operation cost to a certain degree.

In addition, the present invention can effectively inhibit growth of algae by inducing allelopathy of the plants. Moreover, by directionally inducing growth and metabolism of the beneficial indigenous microorganism flora, the microorganism flora structure with high functionality is constructed, and the microorganism enzymatic activity and generation of extracellular polysaccharides are stimulated, so as to reinforce the microorganism purification effect of the floating type purification plant.

### DETAILED DESCRIPTION

Preferred embodiments of the present invention will be illustrated in detail below in connection with embodiments. It should be understood that embodiments given below are merely used for illustration, rather than limiting the scope of the present invention. Those of ordinary skill in the art, without departing from the purpose and the spirit of the present invention, can make various modifications and replacements to the present invention.

Experimental methods used in the below-mentioned embodiments, unless otherwise specifically illustrated, are all conventional methods.

Materials, reagents and the like used in the below-mentioned embodiments, unless otherwise specifically illustrated, all can be obtained by commercial approaches.

### Embodiment 1

Provided is a system for restoring a river and lake water body by a floating type water purification plant. The system sequentially comprises: a grille, a water pump, a pre-magnetization device, a water inlet pipe, an ss sedimentation tank, a magnetizer, a drainage pipe, a water distributing pipe and a floating type purification plant; wherein:

the grille is used for filtering large-particle rubbish, plant residues and large-sized phytoplankton in the river and lake water body; and the specification of a rake tooth grille gap of the grille is 5 mm to 50 mm, and the grille has an installation angle of 60° to 70°, a maximum water passing flow rate of greater than or equal to 160 m³/h and a maximum liquid flow rate of greater than or equal to 0.3 m/s.

The water pump is used for enabling the water body to pass through the grille and lifting the water body passing through the grille to the ss sedimentation tank; the pre-magnetization device is arranged in the water inlet pipe of the ss sedimentation tank, and used for carrying out pre-magnetization on the water body entering the ss sedimentation tank; the pre-magnetization device is a multi-stage permanent magnetic type magnetization device;

the ss sedimentation tank is used for rapidly settling particles in the water body;
the magnetizer is used for carrying out magnetization treatment on the water body treated by the ss sedimentation tank; and
the floating type purification plant utilizes the water body subjected to magnetization treatment by the magnetizer and combines with the plants on the floating type purification plant to carry out purification or restoration on a natural water body.

The floating type purification plant is a cuboid device, and has a size of 3.0 m*1.5 m, an available water depth of 1.5 m and an effective volume of 6.75 m³; aquatic plants, including six plants of canna indica, six plants of phragmites australis, six plants of yellow iris and six plants of iris tectorum, are planted at the upper part of the floating type purification plant, and a planting density is 0.5 to 1 Kg/m²; and the lower part of the floating type purification plant is a dispersed particle filler area.

In a system of constructing the magnetization floating type purification plant to collaborate to reinforce restoration on the river and lake water body, magnetized water formed by regulating different magnetic field intensities in different growth phases of the aquatic plants uniformly enters the movable type purification plant from the upper part through a water outlet pipe and a water distributing pipeline, and has a water inlet flow rate of 1 m³/h and hydraulic retention time of 6 h. After being percolated by a floating type purification bed and passing through the bottom dispersed filler area, the magnetized water is discharged out of the floating type purification plant and enters the river and lake natural water body.

An application method of the system is that:

(1) under the action of the water pump, the river and lake water body passes through the grille to be filtered;
(2) the filtered water body is lifted to the ss sedimentation tank by the water pump through the water inlet pipe, and is subjected to pre-magnetization in the water inlet pipe by the pre-magnetization device arranged in the water inlet pipe;
(3) the water body subjected to pre-magnetization treatment enters the ss sedimentation tank so as to remove particles in the water body;
(4) the water body treated by the ss sedimentation tank enters the magnetizer to be subjected to magnetization treatment under the conditions of a magnetic field intensity of 50 mT to 2,000 mT and magnetization time of 1 min to 30 min; and
(5) the water body subjected to magnetization treatment is distributed at the upper part of the floating type purification plant.

### Embodiment 2

The system and method for restoring the river and lake water body by the floating type water purification plant according to Embodiment 1 are utilized, a floating type purification plant is formed by combination of canna indica, phragmites australis, yellow iris and iris tectorum, and different magnetic field intensities are provided in different growth phases of the canna indica, the phragmites australis, the yellow iris and the iris tectorum, so as to research an induction effect of magnetized water on plant biological hormones in different growth phases of plants.

TABLE 1
Seed Germination Period

| | Magnetic Field | Change Rate | Change Rate |
|---|---|---|---|
| Plant Name | Intensity (mT) | (%) of Cytokinin | (%) of auxin |
| canna indica, | 0 | 18.7 | 21.3 |
| phragmites | 50 | 71.2 | 81.7 |
| australis, | 100 | 77.3 | 77.8 |
| yellow iris and | 300 | 59.2 | 61.7 |
| iris tectorum | 500 | 56.2 | 69.9 |
| | 800 | 57.4 | 66.2 |
| | 1,000 | 53.2 | 67.1 |

In the seed germination period, cytokinin (CK), gibberellins (GA), abscisic acid (ABA) and auxin (IAA) have very high positive correlation to germination of seeds, and control germination of seeds. Therefore, in the seed germination period, an optimal germination magnetic field intensity is explored by researching influence of different magnetic field intensities on the biological hormones such as the cytokinin.

By experiments, it is found that when a magnetic field intensity range is 50 to 100 mT, the biological hormones such as the cytokinin (CK) are effectively induced to be increased, are increased by over 12% compared to other magnetic field intensities, and are increased by over 70% with respect to a case of no magnetic field.

TABLE 2
Plant Growth Period

| | | Change Rate | Change Rate |
|---|---|---|---|
| | Magnetic Field | (%) of Fv/Fm | (%) of Indoleacetic |
| Plant Name | Intensity | Value | Acid Oxidase |
| canna indica, | 0 | 5.7 | 0.2 |
| phragmites | 50 | 19.2 | 3.7 |
| australis, | 100 | 19.3 | 5.1 |
| yellow iris and | 300 | 21.7 | 7.4 |
| iris tectorum | 500 | 28.8 | 12.9 |
| | 800 | 33.7 | 12.1 |
| | 1,000 | 32.8 | 10.7 |
| | 1,200 | 27.6 | 8.7 |
| | 1,500 | 18.4 | 7.2 |
| | 1,800 | 19.1 | 8.7 |
| | 2,000 | 17.3 | 6.7 |

In the plant growth period, an optimal magnetic field intensity for promoting plant growth is explored by measuring secretion amounts of chlorophyll fluorescence and indoleacetic acid oxidase of the plants under different magnetic field intensities.

An experimental result shows that Fv/Fm values of the aquatic plants are all increased to varying degrees under the action of magnetized water of different magnetic fields, and an increase amplitude is 17.3% to 33.7%, wherein the maximum photosynthetic capacities of four kinds of plants all show maximum values in a range of 800 to 1,000 mT, and the final magnetic field intensity should be selected by monitoring photosynthetic activities of four kinds of plants and timely regulating the magnetic field intensity of the magnetized water in two phases of a low temperature and a high temperature so as to determine the optimal magnetic field intensity of a movable type purification plant formed by four kinds of plants. In the magnetic field, secretion of indoleacetic acid oxidase is increased to varying degrees, and is increased by 12.9% under a magnetic field intensity of 500 mT to the greatest degree.

TABLE 3
Plant Decline Period

| | | | Change Rate |
|---|---|---|---|
| | Magnetic Field | Change Rate | (%) of photosynthetic |
| Plant Name | Intensity | (%) of SOD | activity |
| canna indica, | 0 | 12.1 | −18.1 |
| phragmites | 800 | −33.1 | 11.2 |
| australis, | 1,000 | −37.3 | 13.7 |
| yellow iris and | 1,200 | −34.4 | 15.2 |
| iris tectorum | 1,500 | −47.1 | 18.8 |
| | 1,800 | −46.2 | 17.8 |
| | 2,000 | −21.0 | 8.7 |

In the plant decline period, an optimal magnetic field intensity for inhibiting plant decline is explored by measuring the chlorophyll fluorescence and SOD (superoxide dismutase) of the plants under different magnetic field intensities.

An experimental result shows that the photosynthetic activities of the aquatic plants are all increased to varying degrees in different magnetic fields, and an increase amplitude is 8.7% to 18.8%; and the SOD is reduced to varying degrees, and it illustrates that the magnetic field has a good removal effect on the SOD and can effectively inhibit decline of the plants.

### Embodiment 3

The system and method for restoring the river and lake water body by the floating type water purification plant according to Embodiment 1 are utilized, and induction of restoration of a functional flora by different magnetic field intensities is explored by researching influence of different magnetic field intensities on a microorganism flora structure.

TABLE 4
Microorganism Detection Indexes

| | Change Rate | Change Rate |
|---|---|---|
| Magnetic Field | (%) of Abundance | (%) of Abundance |
| Intensity | of Nitrifying Bacteria | of Ammonifying Bacteria |
| 0 | −5.2 | 1.3 |
| 50 | 11.2 | 10.2 |
| 100 | 11.4 | 11.1 |
| 300 | 17.7 | 15.8 |
| 500 | 24.5 | 15.9 |
| 800 | 24.1 | 14.7 |
| 1,000 | 23.3 | 11.2 |
| 1,200 | 13.4 | 5.1 |
| 1,500 | 7.1 | −1.7 |
| 1,800 | 1.2 | −4.7 |
| 2,000 | −3.7 | −13.4 |

An experimental result shows that magnetized water which is magnetized under different magnetic field intensities has an obvious induction effect on nitrifying bacteria and ammonifying bacteria, wherein the maximum abundance of the nitrifying bacteria is 500 mT to 800 mT; and the maximum abundance of the nitrifying bacteria appears in a range of 300 mT to 500 mT.

### Embodiment 4

The system and method for restoring the river and lake water body by the floating type water purification plant according to Embodiment 1 are utilized, and performances of a novel floating type purification plant system are explored by researching the optimal magnetic field intensity for inducing plant growth and increasing an abundance of a functional microorganism flora and doing a comparative study with a conventional ecological floating bed.

TABLE 5
Water Quality Comparison

| | Change Rate | | | | |
|---|---|---|---|---|---|
| Magnetic | (%) of | Removal | Removal | Removal | Removal |
| Field | Trans- | Rate (%) | Rate (%) | Rate (%) | Rate (%) |
| Intensity | parency | of TN | of TP | of BOD | of COD |
| 0 | 18.2 | 11.2 | 5.1 | 23.7 | 11.8 |
| 100 | 21.7 | 23.7 | 33.3 | 54.2 | 43.1 |
| 300 | 28.4 | 24.7 | 27.1 | 56.8 | 44.8 |
| 500 | 38.7 | 30.6 | 24.8 | 59.7 | 48.3 |
| 800 | 39.1 | 29.9 | 29.3 | 64.8 | 50.2 |
| 1,000 | 38.2 | 28.7 | 30.1 | 61.2 | 48.9 |

An experimental result shows that compared to the conventional floating bed, a movable type purification plant subjected to magnetization induction is obviously enhanced in the aspect of the pollutant removal capacity, wherein the highest removal rates of TN, TP, BOD and COD respectively can achieve 30.6%, 33.3%, 64.8% and 50.2%, and are respectively increased by 19.4%, 28.2%, 41.1% and 38.4%.

### Embodiment 5

The system for restoring the river and lake water body by the floating type water purification plant according to Embodiment 1 is utilized, and in order to reflect influence of optimal magnetization solutions in different plant growth phases on river and lake water quality and a microorganism flora, the performance of a novel floating type purification plant system is explored by researching changes of indexes such as transparency, TN, TP, BOD, COD, Ammonifying Bacteria and Nitrifying Bacteria of the water body.

TABLE 6
Performance Comparison

| | | | | | | | Change Rate | Change Rate |
|---|---|---|---|---|---|---|---|---|
| | | | | | | | (%) of | (%) of |
| | Magnetic | Change Rate | Removal | Removal | Removal | Removal | Abundance of | Abundance of |
| | Field | (%) of | Rate (%) | Rate (%) | Rate (%) | Rate (%) | Nitrifying | Ammonifying |
| Growth Phase | Intensity | Transparency | of TN | of TP | of BOD | of COD | Bacteria | Bacteria |
| Germination | 50 | 5.7 | 10.1 | 13.7 | 17.2 | 9.7 | 10.1 | 8.9 |
| Period | 80 | 5.8 | 13.7 | 17.5 | 19.4 | 10.2 | 10.5 | 9.7 |
| | 100 | 5.7 | 16.7 | 19.2 | 21.2 | 11.7 | 10.8 | 10.5 |
| Growth Period | 500 | 40.3 | 39.8 | 32.4 | 61.2 | 48.2 | 23.9 | 15.1 |
| | 800 | 45.2 | 41.3 | 33.3 | 64.7 | 54.7 | 26.1 | 16.2 |
| | 1,000 | 42.7 | 40.1 | 30.4 | 63.9 | 50.1 | 24.1 | 14.7 |
| Decline Period | 1,500 | 27.5 | 16.9 | 19.7 | 41.8 | 34.9 | 7.6 | −2.3 |
| | 1,650 | 27.1 | 20.1 | 20.1 | 46.4 | 37.1 | 5.1 | −4.7 |
| | 1,800 | 25.4 | 17.4 | 17.8 | 34.3 | 30.8 | 0.2 | −15.2 |

An experimental result shows that in different phases of plant growth, a pollution removal effect of a movable type purification plant can be obviously improved by regulating the magnetic field intensity of magnetized water so as to promote transparency of the water body, and growth of indigenous functional microorganisms is induced by magnetization so as to reinforce the purifying capacity of the purification plant.

Although the present invention has been described above in great detail with general descriptions and specific embodiments, on the basis of the present invention, various modifications or improvements may be made, which is apparent to those of ordinary skill in the art. Therefore, all such modifications and improvements without departing from the spirit of the present invention are within the scope of the claims of the present invention.

1. A system for restoring a river and lake water body, comprising:
a grille to filter large-particle rubbish, plant residues, and large-sized phytoplankton in the river and lake water body;
a pre-magnetization device to carry out pre-magnetization on the river and lake water body entering an ss sedimentation tank, wherein the pre-magnetization device is placed in a water inlet pipe of the ss sedimentation tank;
the ss sedimentation tank to settle particles in the water body;
a water pump that enables the water body to pass to the ss sedimentation tank through the grille;
a magnetizer to carry out magnetization treatment on the water body treated by the ss sedimentation tank; and
a floating type water purification plant to carry out purification or restoration on a natural water body utilizing the water body treated by the magnetizer.

2. The system according to claim 1, wherein the pre-magnetization device comprises a multi-stage permanent magnetic type magnetization device.

3. A method for restoring a river and lake-water body, comprising:
enabling, using a water pump, the river and lake water body to pass through a grille;
filtering the water body using the grille;
pumping the filtered water body to an ss sedimentation tank by the water pump through a water inlet pipe
carrying out pre-magnetization on the filtered water body in the water inlet pipe by a pre-magnetization device placed in the water inlet pipe;
enabling the water body subjected to treated in the water inlet by the pre-magnetization device to enter the ss sedimentation tank;
removing particles in the water body using the ss sedimentation tank;
enabling the water body treated by the ss sedimentation tank to enter a magnetizer;
carrying out, by the magnetizer, a magnetization treatment on the water body treated by the ss sedimentation tank, wherein the magnetization treatment is carried out under a magnetic field intensity of 50 mT to 2,000 mT; and
distributing the water body treated using the magnetization treatment at an upper part of a floating type water purification plant, wherein aquatic plants are planted in the floating type water purification plant.

4. The method according to claim 3,
wherein in a seed germination period, the magnetic field intensity is 50 mT to 100 mT;
wherein in a plant growth period, the magnetic field intensity is 100 mT to 1,000 mT; and
wherein in a plant decline period, the magnetic field intensity is 500 mT to 2,000 mT.

5. The method according to claim 3, wherein a magnetization time is between 1 min and 30 min.

6. The method according to claim 3, wherein when an ss content of the water body is greater than or equal to 150 mg/m³, a flocculant is added to carry out flocculating sedimentation.

7. The method according to claim 3, further comprising adding an algicide to remove phytoplankton in the water body wherein when a chlorophyll content of the water body is greater than or equal to 10 mg/m³.

8. The method according to claim 3, wherein the floating type water purification plant uses an expanded polystyrene as a carrier, wherein the floating type water purification plant uses a PVC pipe as a structural framework of a floating type purification bed, and wherein the floating type water purification plant is subject to gravity type fixing by a concrete cone.

9. The method according to claim 8, wherein the upper part of the floating type water purification plant is an aquatic plant planting area, and wherein a lower part of the floating type water purification plant is a dispersed particle filler area, and wherein the aquatic plants further comprise canna indica, phragmites australis, yellow iris and iris tectorum, and a planting density of the aquatic plants is 1 to 2 Kg/m².

10. The method according to claim 9, wherein a filler comprises at least one of a conventional elastic filler or a soft filler.
